(19) United States
(12) Patent Application Publication
(10) Pub. No.: US 2025/0042736 A1
(43) Pub. Date: Feb. 6, 2025

(54) SYSTEMS AND METHODS FOR AUTOMATED SEPARATION AND RECOVERY OF ASTATINE

(71) Applicant: THE TEXAS A&M UNIVERSITY SYSTEM, College Station, TX (US)

(72) Inventors: Evgeny E. TERESHATOV, College Station, TX (US); Jonathan D. BURNS, College Station, TX (US); Lauren A. MCINTOSH, College Station, TX (US); Gabriel C. TABACARU, College Station, TX (US); Sherry J. YENNELLO, College Station, TX (US)

(21) Appl. No.: 18/719,036

(22) PCT Filed: Dec. 14, 2021
(86) PCT No.: PCT/US2021/063241

§ 371 Date: Jun. 12, 2024

(51) Int. Cl. C01B 7/00

(52) U.S. Cl. CPC C01B 7/00

(57) ABSTRACT

Systems and methods for automated separation and recovery of compounds from solution are disclosed herein. In some embodiments, the system can use a pump in fluid/air communication with a chromatography column to dissolve and recover astatine from a solution containing astatine, bismuth, and nitric acid. The system can be in communication with a controller that can automate and/or remotely signal each component of the system to execute the recovery without manual user inputs.

### GOVERNMENT RIGHTS

This invention was made with government support under DOE-Office of Science DE-SC0020958. The government has certain rights in the invention.

### FIELD

The present disclosure relates to systems and methods for separation and recovery of compounds from various media, and more particularly, relates to automated systems and methods for separation and extraction of astatine from a dissolution solution that includes bismuth and astatine dissolved in an acidic medium.

### BACKGROUND

Astatine-211 (²¹¹At) is one of the most promising α-emitting radionuclides for Targeted Alpha Therapy. Targeted alpha therapy (TAT) drugs have gained a large amount of interest in the use of α-emitting radionuclides for treatments of various diseases, e.g., cancers. One such isotope which has drawn a great deal of attention is ²¹¹At, having well-suited decay properties for clinical settings, with a moderately-short half-life of approximately 7.2 hours and a quantitative α-emission from a simple decay scheme. Bombardment of natural bismuth (²⁰⁹Bi) targets with an α-particle beam has been adopted as the standard for generating usable quantities of ²¹¹At via the ²⁰⁹Bi(α,2n)²¹¹At nuclear reaction. With only roughly 30 cyclotrons possessing the ability to generate usable quantities world-wide and just seven of them located in the United States, only one of which is currently a supplier for the US Department of Energy's Isotope Program, the worldwide supply of ²¹¹At remains limited. Despite the low availability, ²¹¹At has been used in a number of clinical trials investigating the treatment of malignant brain tumors, ovarian cancer, and a current study treating advanced hematopoietic malignancies.

The chemistry of astatine is one of the few areas left relatively unexplored on the periodic table. This can be attributed to the fact that astatine's abundance on earth being estimated to be only 0.07 g, the lowest of any naturally occurring element due to lack of stable isotopes. Of the isotopes of astatine, the longest half-life, which is only ˜8.1 h, belongs to ²¹⁰At, which is only slightly longer lived than ²¹¹At.

Currently, two approaches exist for recovery of astatine: wet chemical processing and dry distillation. These conventional approaches for recovery of ²¹¹At from bismuth targets has several shortcomings. First, for analytical scale separations where the amount of ²¹¹At to be recovered and purified is on the order of 1-10 ng, with macro amounts of ²⁰⁹Bi (1-10 g) making up the bulk of the matrix, solvent extraction does not lend itself as an efficient means for separation, as it is limited to a single separation stage per contact. Moreover, analytical scale separations need to be run in a continuous-flow mode, which is the most efficient method for recovery and separation, but requires sophisticated equipment, thereby drastically increasing costs of the process to prevent scalability. Second, these approaches imply that the system conversion from a nitrate to a chloride media, which adds a slow, time-consuming step of either evaporation to remove the nitric acid or chemical destruction of the nitrate ions with hydroxylammonium chloride. Moreover, these conversions can lead to loss of volatile astatine and introduce impurities into the system, e.g., by stripping compounds from the vessels in which they are stored, which hinder ²¹¹At separation and taint the quality of the ²¹¹At upon recovery. Lastly, the instability of the ²¹¹At isotope results in difficulties with storage and shipment of the compound once recovered.

Accordingly, there is a need for improved systems and methods for optimizing separation and purification for recovery of astatine.

### SUMMARY

According to one aspect of the present disclosure, a compound recovery system comprises:

a first column configured to extract astatine from a dissolution solution having astatine dissolved therein, the column having an extraction medium with a solvent associated therewith; a pump in fluid communication with the column, the pump being configured to deliver the dissolution solution to the column; and a control system in communication with the pump, the control system being configured to regulate flow of the dissolution solution through the pump via a signal, wherein the signal is automated or placed from a remote location.

In another aspect, a method for compound recovery comprises:

exposing a target material having one or more compounds therein to an acidic medium to dissolve the target material within the acidic medium to form a dissolution solution having the target material and the one or more compounds therein; passing the dissolution solution through a chromatography column to extract the one or more compounds therefrom, the one or more compounds being extracted into a resin bed disposed within the chromatography column; and washing the resin bed to remove non-extracted dissolution solution from the column, wherein each of exposing the target material, passing the dissolution solution through the chromatography column, and washing the resin bed occurs in response to an automated signal or a signal placed from a remote location.

Additional embodiments, features, and advantages of the disclosure will be apparent from the following detailed description and through practice of the disclosure. The process and compounds of the present disclosure can be described as embodiments in any of the following enumerated clauses. It will be understood that any of the embodiments described herein can be used in connection with any other embodiments described herein to the extent that the embodiments do not contradict one another.

1. A compound recovery system, comprising:
a first column configured to extract astatine from a dissolution solution having astatine dissolved therein, the column having an extraction medium with a solvent associated therewith;
a pump in fluid communication with the column, the pump being configured to deliver the dissolution solution to the column; and
a control system in communication with the pump, the control system being configured to regulate flow of the dissolution solution through the pump via a signal, wherein the signal is automated or placed from a remote location.

2. The system of clause 1, further comprising a dissolution vessel in fluid communication with the pump and the column, the dissolution vessel being configured to form the dissolution solution by mixing an irradiated target material and a medium therein.

3. The system of clause 2, further comprising one or more selectors in fluid communication with the pump, the one or more selectors being configured to deliver the solvent or the dissolution solution therethrough.

4. The system of clause 3, wherein an orientation of the one or more selectors is determined by the signal from the control system.

5. The system of clause 3 or 4, wherein the control system is configured to be in communication with the pump and the one or more selectors substantially simultaneously.

6. The system of any one of clauses 3-5, wherein the one or more selectors contains a single inlet and a plurality of outlets.

7. The system of any one of clauses 3-6, wherein the one or more selectors contains a single outlet and a plurality of inlets.

8. The system of clause 4, wherein the one or more selectors are in fluid communication with one or more vials containing a solution therein, the pump being configured to deliver the medium through the one or more selectors into the dissolution vessel.

9. The system of clause 8, wherein the medium includes one or more of nitric acid, hydrobromic acid, hydrochloric acid, sulfuric acid, or perchloric acid.

10. The system of any one of the preceding clauses, wherein the extraction medium is a resin bed.

11. The system of any one of the preceding clauses, wherein the solvent can include one or more of octanone, 3-octanone, or 1-octanol.

12. The system of any one of the preceding clauses, wherein extraction of astatine occurs without heating.

13. The system of any one of the preceding clauses, further comprising a quality assurance device in fluid communication with the pump being configured to sample a portion of the dissolution solution.

14. The system of any one of the preceding clauses, further comprising a second column configured to receive a portion of the dissolution solution therethrough.

15. The system of clause 14, wherein the second column is arranged in series with the first column.

16. The system of clause 14 or clause 15, wherein the second column is arranged in parallel with the first column.

17. A method for compound recovery, the method comprising:
exposing a target material having one or more compounds therein to an acidic medium to dissolve the target material within the acidic medium to form a dissolution solution having the target material and the one or more compounds therein;
passing the dissolution solution through a chromatography column to extract the one or more compounds therefrom, the one or more compounds being extracted into a resin bed disposed within the chromatography column; and
washing the resin bed to remove non-extracted dissolution solution from the column,
wherein each of exposing the target material, passing the dissolution solution through the chromatography column, and washing the resin bed occurs in response to an automated signal or a signal placed from a remote location.

18. The method of clause 17, wherein the resin bed is washed with the acidic medium.

19. The method of clause 17 or 18, wherein the acidic medium comprises one or more of nitric acid, hydrobromic acid, hydrochloric acid, sulfuric acid, or perchloric acid.

20. The method of any one of the preceding clauses, further comprising washing the chromatography column with an aqueous solution to remove the acidic medium therefrom.

21. The method of any one of the preceding clauses, wherein the dissolution solution is formed approximately over a range of about five minutes to about thirty minutes.

22. The method of clause 20 or clause 21, further comprising eluting the one or more compounds from the resin to collect the one or more compounds.

23. The method of any one of clauses 20-22, further comprising drying the column to remove excess fluid therefrom and sealing the column.

24. The method of clause 23, wherein drying the column further comprises blowing air through the column until excess fluid is substantially removed.

25. The method of clause 24, wherein the column retains the compound after blowing the air through the column.

26. The method of any one of the preceding clauses, the dissolution solution is passed through the chromatography column by a pump that is in fluid communication with one or more selectors disposed between the pump and the column.

27. The method of clause 26, further comprising adjusting an orientation of the one or more selectors in response to a signal.

28. The method of any one of the preceding clauses, further comprising splitting the dissolution solution into a plurality of flows, with each flow entering a separate chromatography column.

29. The method of any one of the preceding clauses, wherein extraction of the one or more compounds occurs without heating.

30. The method of any one of the preceding clauses, further comprising sampling a portion of the dissolution solution to determine an activity level thereof prior to passing the portion to the column.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

This disclosure will be more fully understood from the following detailed description taken in conjunction with the accompanying drawings, in which:

FIG. 1 illustrates a perspective view of an exemplary embodiment of a compound separation and recovery system of the present embodiments having a pump in fluid communication with a series of valves that flow solution to dissolve an irradiated target material and load the dissolution solution onto the column;

FIG. 1B illustrates an alternative perspective view of the system of FIG. 1 having the components in an alternative orientation illustrating system components associated therewith;

FIG. 2A illustrates a perspective view of an embodiment of a valve selector used with the system of FIG. 1 having an inlet and a plurality of outlets formed thereon;

FIG. 2B illustrates a perspective view of another embodiment of a valve used with the system of FIG. 1 having a rotary valve formed thereon;

FIG. 2C illustrates a perspective view of another embodiment of a valve used with the system of FIG. 1 having another embodiment of a rotary valve formed thereon;

FIG. 3 is a schematic diagram of one exemplary embodiment of a control system that can control one or more pumps of the system of FIG. 1;

FIG. 4 is a schematic diagram of one exemplary embodiment of an automated compound recovery system of the present embodiments;

FIG. 5 is a schematic diagram of one exemplary embodiment of a method for separating and recovering a compound from a target material;

FIG. 6A is a schematic diagram of an exemplary embodiment of a sequence of fluid flows through the components the automated compound recovery system of FIG. 4;

FIG. 6B is a schematic diagram of the automated compound recovery system of FIG. 4 in target dissolution mode;

FIG. 6C is a schematic diagram of the automated compound recovery system of FIG. 4 for transfer of a dissolution solution to a QA device;

FIG. 6D is a schematic diagram of the automated compound recovery system of FIG. 4 when the column is being loaded;

FIG. 6E is a schematic diagram of the automated compound recovery system of FIG. 4 for flushing the column with water; and

FIG. 7 is a schematic diagram of one exemplary embodiment of a computer system upon which the control system of the present disclosures is built.

### DETAILED DESCRIPTION

Astatine (At) may be produced by bombarding Bismuth-209 with alpha particles. For example, in some embodiments a target bismuth material is irradiated with alpha particles to produce ²¹¹At within the target material. A person skilled in the art will recognize that this bombardment typically occurs in a particle accelerator, e.g., cyclotron. For example, in some embodiments, Astatine-211 was produced in two separate runs by the ²⁰⁹Bi(α,2n)²¹¹At nuclear reaction via 28.8 MeV α-particle bombardment (˜0.9 barn cross section) of a natural Bi metal target (isotopically pure ²⁰⁹Bi, metal purity ≥99.997% purchased from Goodfellow) for 9-10 h It will be appreciated that the above-described method is purely exemplary and one or more variables can vary in the production process of astatine-211. Moreover, it will be appreciated that to the extent that astatine is described herein, the astatine being referred to may be ²⁰⁹At or ²¹¹At and cationic species thereof. For example, the At described in the process herein may be the cationic species AtO⁺ but will still be referred to as At. Illustratively, the process may include producing the At. The formed bombarded target may comprise a mixture of At, unreacted Bi, and byproducts.

The produced At must be subsequently isolated from unreacted Bi. Described herein is a process that isolates At from compositions, such as the composition formed from bombarding Bi, using extraction chromatography. In illustrative embodiments, the process described herein dissolves a composition comprising At and subsequently isolates the At from the dissolved solution. The described process can be performed without the need to convert the media or solution used to initially dissolve the At/Bi composition, as discussed in greater detail below.

The present disclosure generally relates to systems and methods for automated and/or remotely controlled compound purification and collection. In some aspects, the system can include a series of pumps and valves that coordinate a column-based purification system and the methods include an approach for rapid separation and purification of the alpha-emitting therapeutic radioisotope ²¹¹At from dissolved cyclotron targets. In one aspect, the system can dissolve a target material into solution. In such embodiments, the system can contact the irradiated target material with an aqueous solution to dissolve the bismuth and the astatine into a dissolution solution.

The aqueous solution can include an acid, for example an organic acid or a mineral acid. The mineral acid may be nitric acid. The solution dissolves or substantially dissolves the composition to form a solution comprising At and Bi. In some embodiments, the solution comprises At, Bi, and an acid. In some embodiments, the solution comprises At, Bi, and nitric acid. The target can be dissolved in a solution composed of variety of media. Some additional non-limiting examples of the aqueous solution can include hydrobromic acid, hydrochloric acid, sulfuric acid, or perchloric acid.

In some aspects, the solution has a particular concentration of acid or is adjusted prior to subsequent steps to have a particular concentration of acid. Illustratively, the acid may assist in dissolving the composition. For example, the presence of nitric acid may aid in dissolving a bombarded Bi target.

Illustratively, the acid concentration may be about 1 M to about 10 M, about 1 M to about 8 M, about 2 M to about 8 M, or about 3 M to about 7 M. The concentration of acid may be about 1 M, about 2 M, about 3 M, about 4 M, about 5 M, about 6 M, about 7 M, about 8 M, about 9 M, or about 10 M. The concentration of acid maybe adjusted depending on the partition coefficient in a solvent used in subsequent steps. The ranges described herein are equally applicable when the acid is an organic acid or a mineral acid such as nitric acid.

The time taken for the target to sufficiently dissolve in the acidic medium can vary based on the medium used. For example, a target material having ²⁰⁹Bi and ²¹¹At therein can dissolve approximately over a range of about two minutes to about an hour, about five minutes to about thirty minutes, about eight minutes to about twenty minutes, or about ten minutes to about fifteen minutes. In embodiments in which the ionic media includes nitric acid, the target material can sufficiently dissolve in about ten minutes to form the dissolution solution.

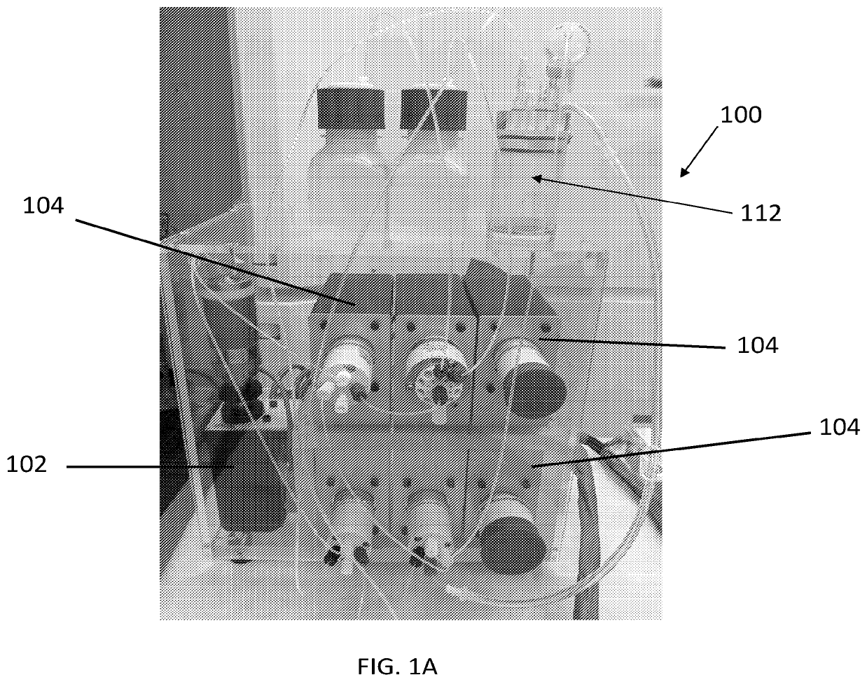

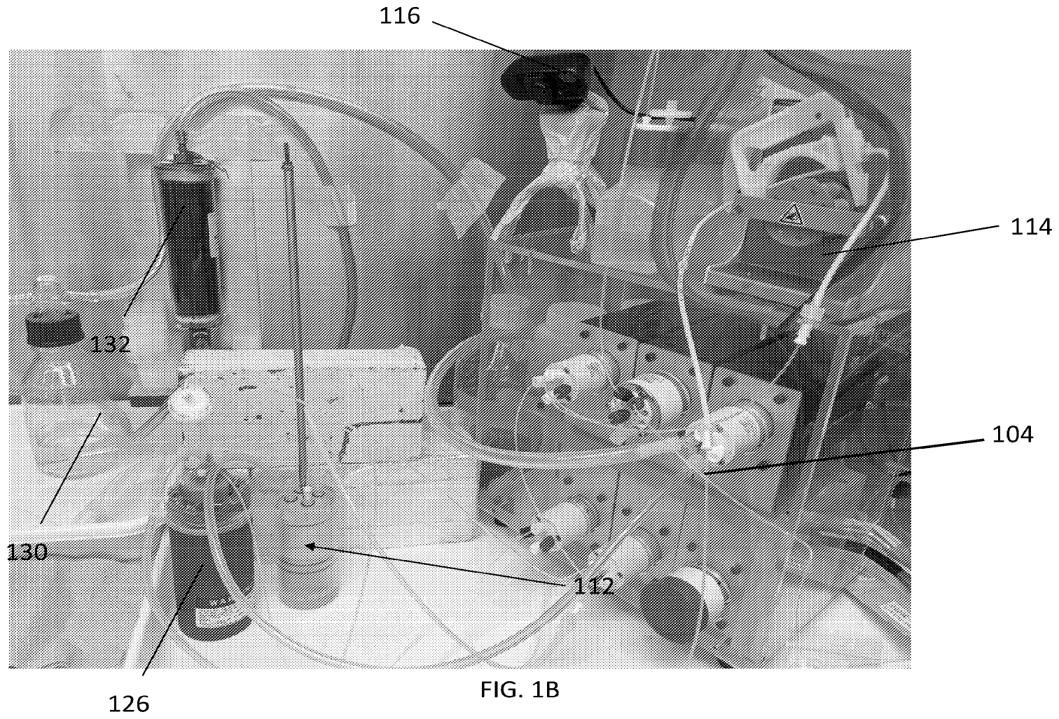

FIGS. 1A-1B illustrate an exemplary embodiment of a compound separation and recovery system 100 that extracts one or more compounds from a dissolution solution. While the system of the present embodiments is discussed with respect to recovery of astatine from a dissolution solution formed by dissolving a target having bismuth and astatine in nitric acid, one skilled in the art will recognize that the presently disclosed system and methods can be applied to extraction and recovery of a variety of compounds from solution, e.g., drug samples from bodily fluids, proteins from virus serums, and other inorganic substances obtained upon dissolution of different irradiated cyclotron targets.

As shown, the system 100 can include a pump 102 that is connected to a series of valves or selectors 104 for flowing fluids throughout the system 100. The pump 102 can be used to set flow rates of any fluid circulating through the system. For example, the pump 102 can flow an acidic medium and/or the dissolution solution throughout the system at the same flow rates, at different flow rates, at flow rates that vary over time, and so forth. Some non-limiting examples of the pump of the present embodiments can include a peristaltic pump, syringe-free pump, diaphragm pump, piston pump, gear pump, vane pump, positive displacement pump, and/or centrifugal pump, among others.

In some embodiments, the pump 102 can be regulated to change a flow rate of the liquids flowing through the system in response to an input. For example, in some aspects, the pump 102 can be remotely controlled by a signal from a control system 200 to direct sequences of flows throughout the system. The signal can be generated automatically via a program, remotely via a user input, and/or manually by an indication to increase and/or decrease a flow rate. For example, flow rates of the solution through the system can be approximately 365 mL/min, though in some embodiments, can range from approximately 0.0002 mL/min to 35 mL/min, while the flow rate of the dissolution solution can range from approximately 0.0002 m/min to 35 m/min. The control system 200 that controls the pump and the fluid flow is discussed in greater detail below.

The pump 102 can be in fluid communication with the series of valves 104. The valves 104 can be configured to change position between various orientations to flow fluid in a given direction within the system 100. For example, the position of each valve 104 can be changed by a signal received from the pump and/or the control system 200, which would change a direction of the flow of fluid therethrough.

FIG. 1B illustrates additional components of the compound separation and recovery system 100. In addition to the valves 104 and the dissolution box 112, the system 100 can include an alternative peristaltic pump 114, a USB camera 116, a QA device for activity sampling, a scrubber 130 containing sodium hydroxide solution, a charcoal vat 132 for removing astatine vapors. These components and their uses will be discussed in greater detail below.

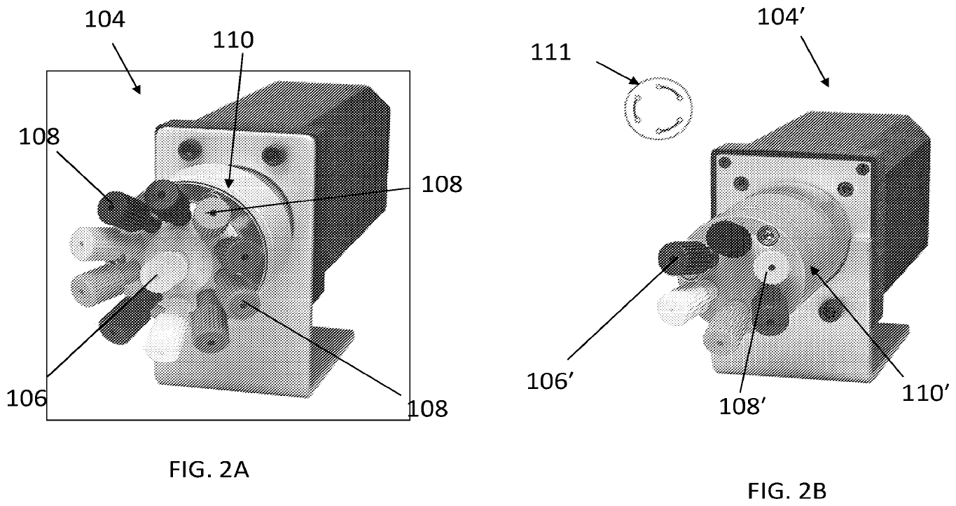

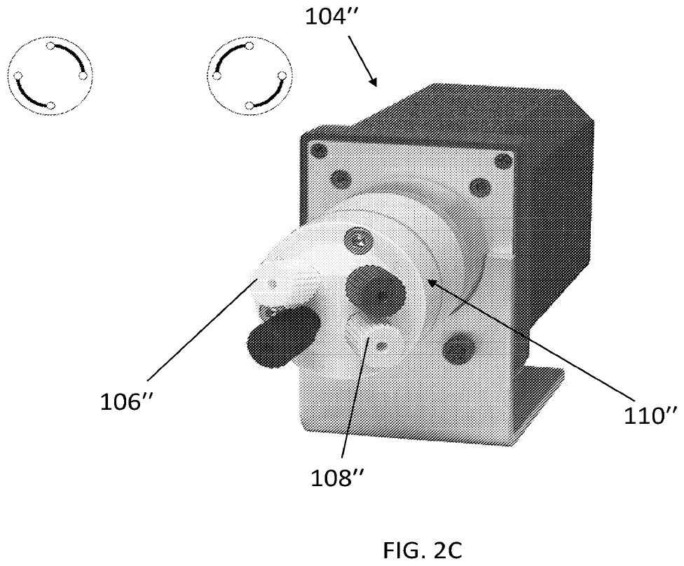

FIGS. 2A-2C illustrate the valves 104 in greater detail. Each valve 104 can include an inlet 106 and a one or more outlets 108 for distributing fluid throughout the system. As shown in FIG. 2A, a selector 104 of the present embodiments can include a single inlet 106 and ten outlets 108 extending therefrom, though it will be appreciated that in some embodiments, the selector 104 can include nine or fewer outlets 108 or eleven or greater outlets 108. The plurality of outlets can support mixing or splitting of a batch of fluid flows into separate components of the system 100, e.g., multiple chromatography columns, as discussed further below. In some aspects, the selectors 104 can be two-way selection valves to support flow from a source in a first direction and flow back to the source in a second, opposite direction.

In some embodiments, the inlets and outlets can be reversed such that the selector can have a plurality of inlets and a single outlet. For example, the selector 104 can include a plate 111 with a straight groove located behind a selector stator, e.g., head with ports, 110, in which the groove connects the inlet 106 to one of the outlets 108 at a time via a step-wise rotation of the plate 111. It will be appreciated that in embodiments in which the selector 104 includes a single outlet and a plurality of inlets, the plate 111 can similarly rotate to align the outlet 108 with an inlet 106.

FIG. 2B illustrates an alternate embodiment of a valve 104′ of the present embodiments having a rotary valve 110′ thereon. The rotary valve 110′ can include a series of inlets 106′ and outlets 108′ arranged in a substantially circular arrangement on a periphery thereof. The rotary valve 110′ can be rotated by the pump 102 and/or the control system 200 to change a position of the valves to regulate the flow passing therethrough. The advantage of this type of valve is its ability to connect two neighboring ports at a time, allowing work with two streams simultaneously. For example, considering a 4-port valve, there are two possible positions, namely A and B, where position A connects port 1 to port 2 and port 3 to port 4, while position B connects port 1 to port 4 and port 2 to port 3. By comparison, the selector 104 can deal with only one stream at a time, by connecting port 106 to one of the ports 108.

FIG. 2C illustrates yet another embodiment of a valve 104′ of the present embodiments having another rotary valve 110″ thereon. Unlike the six-port valves 104′ of the embodiment of FIG. 2B, the present embodiments include a four-port valve 104″, as shown. It will be appreciated that in some embodiments, two-port, three-port, or valves having six or more ports, e.g., eight, ten, and so forth, can be used.

A person skilled in the art will recognize that positions of the selectors 104 or valves 104′ can be controlled in tandem with the pump 102, though in some embodiments, the valves can be controlled independently. In some aspects, changes in position of the selectors 104 or valves 104′ can occur in response to a program, a remote user input, and/or a manual rotation of the valves. The selectors 104 or valves 104′ can flow fluid or gas/air to other system components, e.g., a chromatography column (not shown), a quality assurance device, and so forth, as discussed further below. It will be appreciated that each selectors 104 or valves 104′ can be controlled independent of the other valves and/or the remaining components of the system 100.

In some embodiments, the selectors 104 or valves 104′ can flow solution to the target material to form the dissolution solution. As shown, the system 100 can include a dissolution box or vessel 112 configured to store materials or solutions for formation of the dissolution solution. In one aspect, the dissolution box 112 can be configured to receive the target therein. For example, once the target has been irradiated, the target can be placed in the dissolution box 112. Moreover, the dissolution box 112 can be in fluid communication with the other system components to receive a solution that dissolves the bismuth and the astatine to form the dissolution solution. That is, the dissolution box 112 can be configured to receive fluid via the pump 102 to dissolve a material placed therein. The dissolution box 112 can be in fluid communication with reservoirs (up to 10 according to FIG. 2A) containing mineral or organic acids, and/or pure water to create a mixture solution of desired concentration in the dissolution box 112.

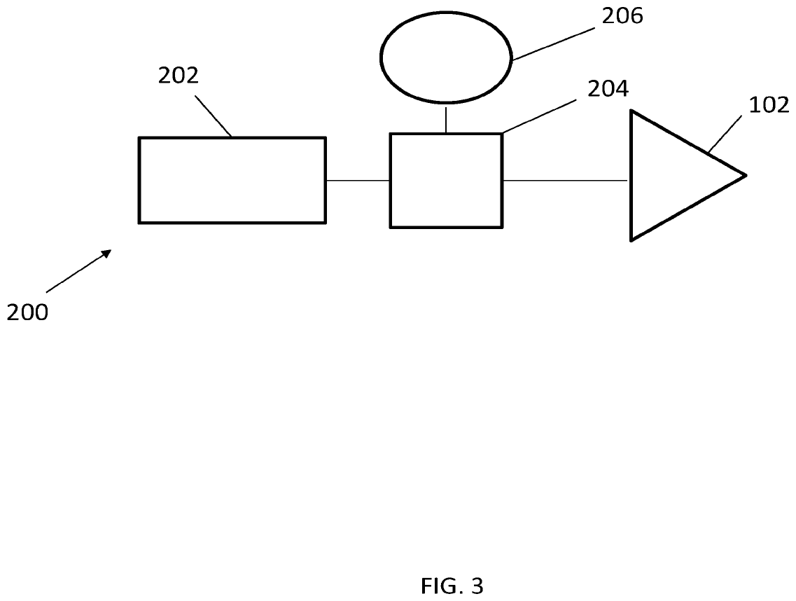

As noted above, the compound recovery system 100 of the present embodiments can include a control system 200, sometimes referred to as a controller, and an example of which is shown in FIG. 3. The control system 200 can be in communication with each of the components of the system 100 to control the behavior thereof. In some aspects the control system 100 can be a personal computer or another computing source known to one skilled in the art that can control flow rate and direction of fluid/air flow throughout the system 100. In some embodiments, control of fluid/air flow rate and direction can occur by signaling the pump 102 and the selectors 104 or valves 104′, respectively, to flow fluid/air according to inputs into the control system 200. As noted above, the inputs in the control system 200 can be automated and/or placed from a remote location, allowing the system 100 to operate without manual inputs.

The control system 200 can include a microcontroller 202 that can send a control signal to a switch 204. The control signal can be used to regulate a volumetric flow rate of the fluid/air with the pump 102. In some embodiments, the microcontroller 202 can be configured to output a signal to other components of the system, e.g., the selectors 104, the column, the QA device, and so forth. The switch 204 can be connected to a power source 206, e.g., a direct current (DC) unit. It will be appreciated that the control system 200 can be connected to the pump 102, as shown, though in some embodiments the control system 200 can further connect to the selectors 104, the column, the QA device, and other system components, as discussed in greater detail below.

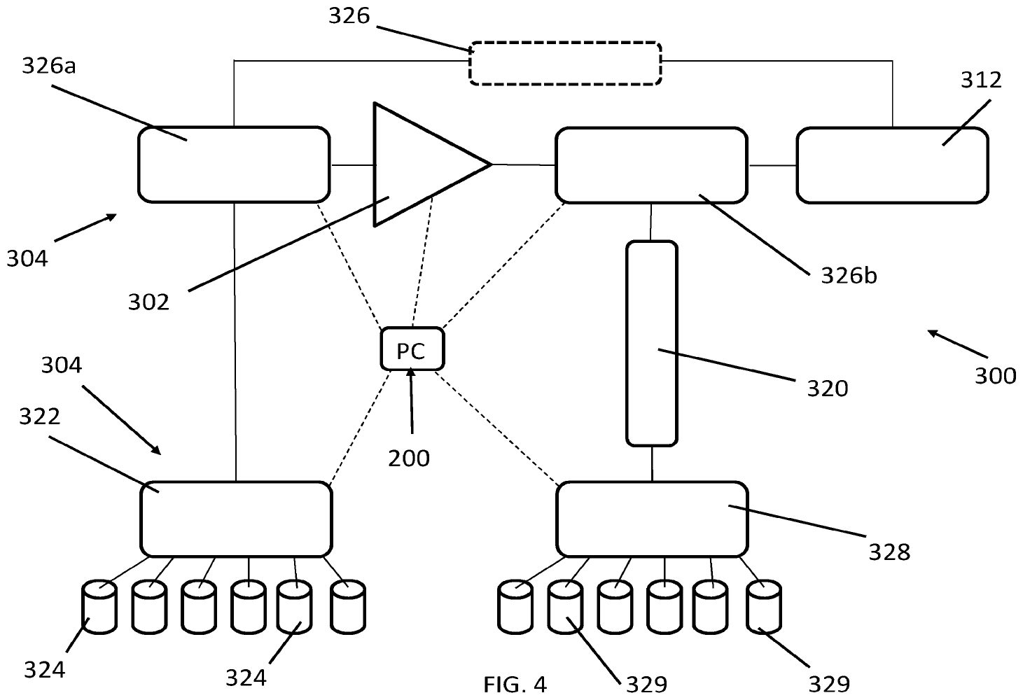

FIG. 4 illustrates the schematics of an exemplary embodiment of an automated compound recovery system 300 of the presented embodiments in greater detail. As shown, the system 300 can include the pump 302, a plurality of valves/selectors 304, the dissolution box 312, and a column 320. The plurality of valves/selectors 304 can be placed throughout the system 300 to facilitate introduction of fluids/air into the system and distribution of fluid/air throughout the system. For example, as shown, the plurality of valves/selectors 304 can include a solution selection valve 322 that is in fluid communication with one or more vials 324 having a solution therein. For example, as shown, the solution selection valve 322 can be configured to receive fluid from the vials 324 for distribution throughout the system 300. In one aspect, the solution within the vials 324 is the acidic medium, e.g., nitric acid. The solution selection valve 322 can be connected to a two-way selection valve 326a that flows to the pump 302 to flow the solution to the dissolution box 312 containing the irradiated target material therein.

The controller 200 can be in communication with the pump 302 and each of the plurality of valves 304 to automate fluid/air flow throughout the system 300 and to coordinate the sequence of flows. The controller 200 can control a plurality of components in the system substantially simultaneously. For example, in some embodiments, the controller 200 can signal the pump 302 and the solution selection valve 322 to collect solution from the vials 324 and flow the solution to the dissolution box 312. While flowing the solution towards the dissolution box 312, the controller 200 can signal the two-way selection valves 326a, 326b to open to allow the fluid/air/gas therethrough. Similarly, once the dissolution solution is prepared, the controller 200 can signal the two-way selection valve 326b to change orientation such that the dissolution solution flows out of the dissolution box 312 and into the column 320 to begin astatine recovery.

When the target material is sufficiently dissolved, the dissolution solution can travel through another valve 326b to the column 320 for separation and extraction of the astatine from the dissolution solution. Astatine and bismuth separation after the metallic target dissolution in nitric acid is important in the instantly disclosed system for preparation of a final product. The column 320 can be configured to undergo an extraction chromatography process when the dissolution solution enters the column 320. Liquid phase based chemistry is considered to be a more reliable approach than dry distillation for astatine recovery. Use of extraction chromatography in the present embodiments is superior to conventionally used tellurium columns, as a person skilled in the art will recognize that passing fluid through tellurium columns can lead to lower astatine recovery yields and strip the compounds from the walls of the column, thereby contaminating the astatine product contained therein.

In some aspects, the At is isolated by using a resin in ion exchange chromatography. The resin may be in the form of a resin bead. The resin beads may be spread throughout a length of the column 320. Alternatively, the resin may be used in a bulk process. Illustrative resins include polymeric beads and glass beads. In some embodiments, the bead comprises a zeolite, a molecular sieve, a polymeric resin, or glass beads. In some embodiments, the bead is porous. The bead may be inert. In some embodiments, the bead comprises a styrene-divinylbenzene copolymer. In some embodiments, the benzene of the copolymer does not contain a functional group.

In some embodiments, the porous resin is a poly-acrylate resin or a porous glass bead. Amberchrom® CG300M porous beads with a pore volume of 0.7 mL g⁻¹¹ and a particle size of 50-100 μm slurry in 20% ethanol purchased from Sigma-Aldrich can be used in extraction chromatography. Amberchrom® CG300M is a styrene-divinylbenzene copolymer with no functional group on the benzene ring. In some embodiments, prior to use, the beads can be dried at 80° C. for a minimum of 24 h to remove any solvent from the pores.

The resin bed can include a biologically friendly ligand incorporated therein. In one aspect, the ligand is an organic solvent that is incorporated into the resin bed, though it will be appreciated that other compounds, such as an alcohol, aldehyde, a ketone, a water immiscible ketone, organic acids, an ester, an ether, an amide, a carbonate, a carboxylate, a carbamate, and/or organophosporus compounds, e.g., trialkylphosphine oxides and trialkyl phosphates can be incorporated into the beads. For example, the dried resin can be impregnated with one or more of octanone, 3-octanone, and so forth, by soaking the beads in the organic solvent. The organic solvent can be used for sorption on the beads to extract the astatine from the dissolution solution while the remainder of the dissolution solution passes through the column. For example, for a dissolution solution containing bismuth and astatine, the ²¹¹At extracts into the organic solvent impregnated into the resin bed, while bismuth, which is a major constituent of the dissolution solution does not extract. The organic solvent can therefore separate the dissolution solution such that the resin bed contains the ²¹¹At extract while the bismuth remains in solution. Some additional non-limiting examples of the organic solvent can include an alcohol, aldehyde, a ketone, an immiscible ketone as an organic phase, such as n-octanone, where n=1, 2, 3, methylisobutylketone, decanone, an ester, an amide, a carbonate, a carboxylate, water immiscible alcohols, organic acids, organophosphorus compounds, and/or a carbamate.

In some embodiments, the organic solvent is polar. In some embodiments, the organic solvent comprises an optionally substituted C₁-C₁₈ alkyl where each hydrogen atom of the C₁-C₁₈ alkyl is optionally substituted by a functional group. Optional substituents on C₁-C₁₈ alkyl are commonly known in the art and include halogens, hydroxyls, amines, thiols, oxo, ketones, carboxylates, aldehydes, amides, carbonates, carbamates, combinations thereof, and the like. In some embodiments, the organic solvent comprises an aldehyde, a ketone, an ester, an amide, a carbonate, a carboxylate, or a carbamate. In some embodiments, the organic solvent comprises a C₁-C₁₈, C₁-C₁₂, or C₁-C₆ alkyl comprising an aldehyde, a ketone, an ester, an amide, a carbonate, a carboxylate, or a carbamate. In some embodiments, the organic solvent is of the formula C₁-C₆ alkyl-C(O)—C₁-C₆ alkyl. In some embodiments, the organic solvent is of the formula C₁-C₆ alkyl-C(O)—C₁-C₆ alkyl, wherein each hydrogen atom in C₁-C₆ alkyl is optionally substituted. In some embodiments, the organic solvent is a C₁-C₁₈ alkanol. Illustratively, the organic solvent may comprise a mixture of the organic solvents described herein.

In some aspects, the solvent of the impregnated resin is a solvent that provides a D-value partition coefficient for At of at least 10 against an aqueous solution, such as an aqueous solution comprising nitric acid. In illustrative embodiments, At has a D-value partition coefficient in the organic solvent of at least about 20, at least about 40, at least about 60, or at least about 80. Illustratively, the partition coefficient may be measured against an aqueous solution comprising an acid, such as nitric acid. In some embodiments, At has a partition coefficient of at least about 20 or at least about 40 between octanone and an aqueous solution comprising about 2-6 M nitric acid.

The term “alkyl” refers to a straight- or branched-chain monovalent hydrocarbon group. In some embodiments, it can be advantageous to limit the number of atoms in an “alkyl” to a specific range of atoms, such as C₁-C₁₈ alkyl, C₁-C₁₂ alkyl, or C₁-C₆ alkyl. Examples of alkyl groups include methyl (Me), ethyl (Et), n-propyl, isopropyl, butyl, isobutyl, sec-butyl, tert-butyl (tBu), pentyl, isopentyl, tert-pentyl, hexyl, isohexyl, and groups that in light of the ordinary skill in the art and the teachings provided herein would be considered equivalent to any one of the foregoing examples. It will be appreciated that an alkyl group can be unsubstituted or substituted as described herein. An alkyl group can be substituted with any of the substituents in the various embodiments described herein, including one or more of such substituents. The term “alk-” may form a prefix with the remainder being a functional group. For example an “alkanol” is an alkyl group substituted with an alcohol.

The term “substituted” means that the specified group or moiety bears one or more substituents. The term “unsubstituted” means that the specified group bears no substituents. Where the term “substituted” is used to describe a structural system, the substitution is meant to occur at any valency-allowed position on the system. In some embodiments, “substituted” means that the specified group or moiety bears one, two, or three substituents. For example, two hydrogen atoms on a carbon of an alkyl group may be substituted by an oxo (═O) group to form carbonyl (C═O). In other embodiments, “substituted” means that the specified group or moiety bears one or two substituents. In still other embodiments, “substituted” means the specified group or moiety bears one substituent. A person skilled in the art will recognize that the term “halogen” or “halo” represents chlorine, fluorine, bromine, or iodine.

Conventional methods of astatine capture include dry distillation in which the target is heated until the dissolution solution turns into a gas which is then recovered. The system and methods of the present embodiments require no heating. Rather, use of the solid resin bed impregnated with organic solvent for extracting the astatine from the dissolution solution improves efficiency of the extraction of astatine in the present embodiments and enables the presently disclosed system to be automated. For example, by performing the dissolution of the irradiated target in the same acidic medium as the medium used for recovery, e.g., a nitric acid medium, extraction and recovery of the astatine can be expedited without need for additional chemical manipulation nor evaporation of the dissolution solution. Conventional chromatography techniques utilize a liquid-liquid extraction process in which two immiscible liquids interact to extract the compound, e.g., astatine, from the dissolution solution. Use of a liquid when performing the extraction requires conversion of a solvent in order for the desired compound to be extracted, which results in multiple liquid-liquid extraction steps that occur in the column. For example, when a nitric acid medium is used to form the dissolution solution in conventional chromatography, the nitric acid medium needs to be converted to a hydrochloric medium, e.g., hydrochloric acid, along with development of a phase boundary sensor before the astatine can be extracted. After conversion, the dissolution solution reacts with the hydrochloric medium in the conventional methods to extract the astatine therefrom. In some embodiments, the liquid-liquid extraction process can further require chemical destruction of the nitrate with hydroxylammonium chloride, as noted above, and/or heating to complete the extraction process. By way of comparison, the solid-liquid extraction of the present embodiments performs extraction of the compound directly from the nitric media without conversion, which results in greater conversion efficiency and a shorter duration for extraction. Moreover, the solid-liquid extraction process with the resin bed of the present embodiments occurs without heating. Still further, in some aspects, the solid-liquid extraction process can be run under continuous flow, rather than batch flow, which further increases efficiency and reduces duration of recovery of astatine from the dissolution solution. For example, under continuous flow, solution passing through the column 320 can contact multiple stages of beads on its way therethrough, thereby repeatedly exposing the solution to the organic solvent impregnated therein to increase the recovery of the compound of interest. That is, the solution flows continuously from one stage of beads to the next, with extraction of the astatine occurring at each stage.

In some embodiments, the system can include a quality assurance (QA) device or product vial 326 for measuring activity of the dissolution solution. For example, a portion of the dissolution solution can flow to the QA device 326 to measure various parameters of the dissolution solution, such as concentration, liquid fraction, activity, radioimpurity and dose rate. As shown, the QA device 326 can be a tube that is in fluid communication with the dissolution box 312. Once sampled, the dissolution solution can be loaded into the column 320 to recover astatine therefrom.

In some embodiments, frequency of flowing the dissolution solution through the QA device 326 can be tapered over time. For example, sampling can occur more frequently towards the beginning of the extraction process to ensure that activity of the dissolution solution is within acceptable ranges. As the process continues, flow of fluid through the QA device 326 can become less frequent and can eventually be discontinued so long as the activity levels are maintained within the desired ranges. The activity level can be monitored by the control system 200, with the control system being configured to restart and/or increase frequency of sampling if the activity levels of the dissolution solution deviate from the accepted ranges.

The QA device 326 can have a volume that approximately ranges from about 20 milliliters to about 80 milliliters, about 30 milliliters to about 70 milliliters, about 40 milliliters to about 60 milliliters, or have a value of about 50 milliliters. A person skilled in the art will recognize that the volume of the QA device can be chosen such that a sufficient sample is tested to verify that the dissolution solution includes a desired relative concentration of the bismuth and astatine products.

The system 300 can be controlled remotely. For example, the controller 200 can be programmed to automate the collection of astatine without manual input from a user. In such embodiments, personnel can monitor the chemical processes that occur during irradiation, separation, and/or recovery without manually interacting with the components, thereby reducing doses of exposure of radiation and/or harmful chemicals to personnel. Moreover, once the target is placed in the dissolution box 312, the control system 200 can regulate the system 300 remotely from a user. It will be appreciated that while the system is automated, one or more features or inputs can be performed manually.

Once recovery of the astatine is complete, in some embodiments, the column 320 can be in fluid/air communication with one or more fraction collection valves 328. As shown, astatine can flow out of the column 320 through a fraction collection valve 328 to one or more dispensing vials 329. Each fraction collection valve 328 can connect to the dispensing vials 329 to collect a given amount of astatine therein. The amount of astatine flowing through the valve 328 can be automated by the control system 200, with each valve 328 receiving equal amounts of astatine, though in some embodiments, each vial 329 can receive independent and different amounts. In some embodiments, waste product can flow out of the column 320 through the fraction collection valve 328 to be disposed of in compliance with health and safety laws.

Further, a person skilled in the art will recognize that variations of the system are possible. For example, while a single column is shown in FIG. 4, in some embodiments, the batch of dissolution solution flowing from the dissolution box 312 can be split among a plurality of columns. The plurality of columns can be equally sized and/or of equal geometry, though in some embodiments, the columns can be of different sizes and/or of different geometries. Moreover, the columns in the plurality of columns can include the same resin/bed therein though in some embodiments, the columns in the plurality of columns can include different resin/beds therein. In some embodiments, the plurality of columns can be arranged in series, such that a single flow of solution passes through two or more columns. In alternate embodiments, the plurality of columns can be arranged in parallel, such that a batch of dissolution solution is split prior to flowing through the columns.

In some aspects, the column 320 can retain astatine therein without it being collected in the dispensing vials 329. For example, in some embodiments, no astatine flows into dispensing vials distal to the column 320 after the astatine has been recovered. Rather, in such embodiments, the fraction collection valve 328 can flow waste material, e.g., the dissolution solution containing bismuth and nitric acid, from the recovery process therethrough to be discarded. The recovered astatine can instead remain in the column 320 with the organic solvent, and air can be blown through the column to remove any excess liquid through the fraction collection valve 328. Once the column is sufficiently dried, the column with the concentrated solution of astatine impregnated within the resin bed can be packaged and shipped for use in other systems.

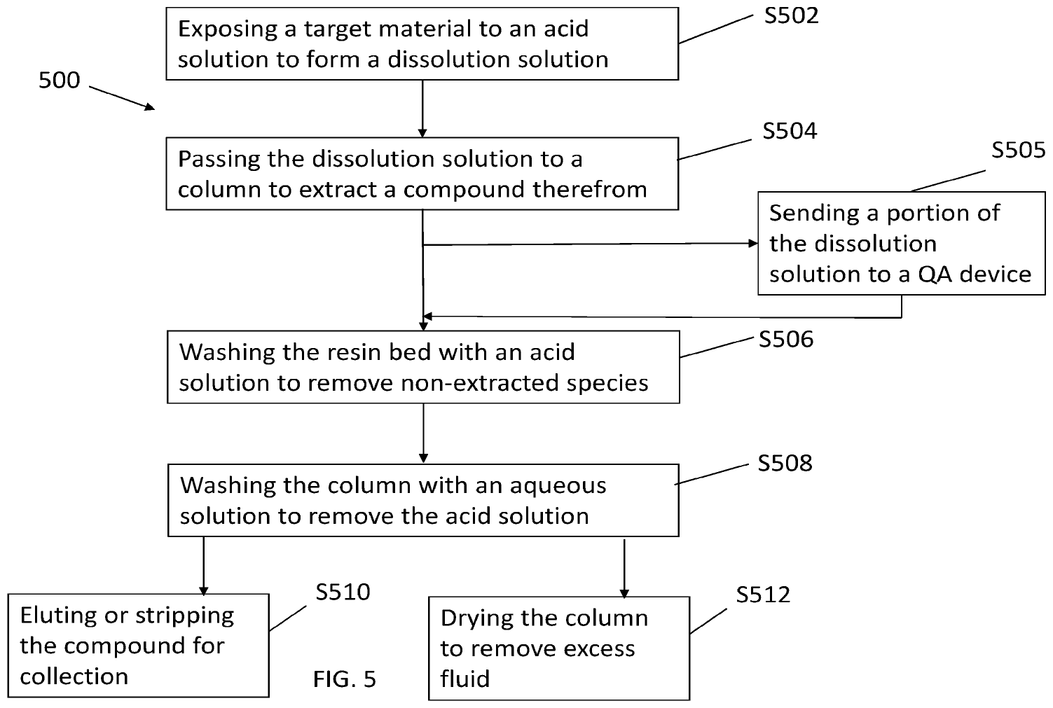

FIG. 5 illustrates an exemplary method 500 of recovering a compound of interest using the presently disclosed system. As discussed above, while the present method will be discussed with respect to recovery of astatine from a ²⁰⁹Bi target material irradiated with alpha particles, the steps of the presently disclosed method 500 can be used to separate and recover various compounds of interest from solution. Moreover, it will be recognized that the control system 200 can automate and/or remotely control each of the steps of the method 500 by signals sent to one or more components of the system, as described in detail above.

As shown, the irradiated target material having bismuth and astatine therein can be exposed to a solution of nitric acid to form a dissolution solution in which the bismuth and the astatine dissolve in the nitric acid (S502). In some embodiments, exposure of the target material can occur in the dissolution box, with the target material being placed therein and the nitric acid solution being directed thereto. In some aspects, the control system 200 can direct one or more of the pump 302 and/or the valves 304 to flow the nitric acid solution to the dissolution box 312. In some embodiments, the control system 200 can remotely signal the solution selection valve 322 to flow the nitric acid solution therethrough, while signaling the pump 302 to flow the nitric acid solution to the dissolution box 312. The solution can flow to the target material substantially continuously and/or in batches to facilitate dissolution of the target material.

Once the target material sufficiently dissolves in the nitric acid to form the dissolution solution, the dissolution solution can be passed to the column (S504). As shown in FIG. 4, the dissolution solution can flow through the two-way selection valve 326b to the column 320, though in some embodiments, the dissolution solution can flow directly to the column 320 from the dissolution box 312. In the column 320, the dissolution solution can contact the resin bed impregnated with the organic solvent to extract the astatine therefrom.

Optionally, in some embodiments, a portion of the dissolution solution can flow towards the QA device 326 for measuring activity of the dissolution solution (S505). In such embodiments, the QA device 326 can sample the dissolution solution to measure an activity level of the dissolve astatine therein. Once sampled, the dissolution solution can flow back through the two-way selection valves 326a, 326b into the column 320 for recovery of astatine therefrom.

After contacting with the solution containing a mixture comprising At, the resin may be washed (S506). The step of washing may include washing the resin with an aqueous solution. In some embodiments, the aqueous solution comprises an acid. In some embodiments, the aqueous wash solution comprises an acid at a lower concentration than the acid concentration used to dissolve the At/Bi composition. For example, if the acid concentration is about 6 M in the aqueous solution that dissolves the At/Bi composition, the acid concentration in the wash solution may be less than about 6 M, for example about 2 M. In some embodiments, the concentration of acid is less than about 10 M, less than about 8 M, less than about 6 M, or less than about 4 M. In some embodiments, the concentration of acid is up to about 8 M, up to about 6 M, or up to about 4 M. In illustrative embodiments, the acid used in the wash steps is the same acid, for example nitric acid, as the acid in the previous steps.

Alternatively, the acid may be a different acid. For example, the acid may be HClO₄, HCl, HBr, or H₂SO₄. Illustratively, changing the acid used in the wash step may change the counterion of the isolated At recovered by the eluting step.

In some embodiments, the step of washing the resin is measured as ratio of bed volumes. For example, the resin may be washed with a solution having a volume of at least about 2, at least about 3, at least about 4, at least about 5, or at least about 6 bed volumes. In illustrative embodiments, the resin may be washed sequentially with an aqueous solution containing an acid and an aqueous solution free of an acid. The washing steps may be adjusted by means known in the art to include additional or fewer washing steps of aqueous solutions.

In embodiments in which the aqueous wash solution includes an acid, a separate washing step can be used to remove the acid from the column (S508). For example, an aqueous solution of water can be used to wash the column to remove the acid therefrom. Once the acid is washed away, the column can include the resin bed having the extracted ²¹¹At adhered thereto.

In some embodiments, the astatine can be eluted or stripped from the resin (S510). Illustratively, the step of eluting dissociates the At from the resin to allow for the At to be collected. The eluting step may be performed by contacting the resin with an organic solvent. In some embodiments, the organic solvent is the same solvent that impregnates the resin. In some embodiments, the organic solvent in the eluting step is miscible with the solvent that impregnates the resin. In some embodiments, the organic solvent comprises an optionally substituted C₁-C₁₈ alkyl where each hydrogen atom of the C₁-C₁₈ alkyl is optionally substituted by a functional group. Optional substituents on C₁-C₁₈ alkyl are commonly known in the art and include halogens, hydroxyls, amines, thiols, oxo, ketones, carboxylates, aldehydes, amides, carbonates, carbamates, combinations thereof, and the like. In some embodiments, the organic solvent comprises an aldehyde, a ketone, an ester, an amide, a carbonate, a carboxylate, or a carbamate. In some embodiments, the organic solvent comprises a C₁-C₁₈, C₁-C₁₂, or C₁-C₆ alkyl comprising an aldehyde, a ketone, an ester, an amide, a carbonate, a carboxylate, or a carbamate. In some embodiments, the organic solvent is of the formula C₁-C₆ alkyl-C(O)—C₁-C₆ alkyl. In some embodiments, the organic solvent is of the formula C₁-C₆ alkyl-C(O)—C₁-C₆ alkyl, wherein each hydrogen atom in C₁-C₆ alkyl is optionally substituted. In some embodiments, the organic solvent is octanone. In some embodiments, the organic solvent is 3-octanone. In some embodiments, the organic solvent is a C₁-C₁₈ alkanol. In some embodiments, the solvent comprises ethanol.

Illustratively, the process described herein recovers at least about 80%, at least about 85%, at least about 90%, or at least about 95% of the At from the composition comprising At. In some embodiments, the process recovers about 80% to about 99%, about 85% to about 99%, or about 90% to about 99% of the At from the composition comprising At.

Illustratively, the eluted At has a purity higher for At than the composition comprising At prior to the chromatograph step. In some embodiments, the eluted At has a purity of at least about 90%, at least about 95%, or at least about 99%.

The process described herein may be performed in less than about 1 hour, less than about 30 minutes, less than about 15 minutes, or less than about 10 minutes. Illustratively, the process is performed in less time compared to a comparative process that requires a step of dissolving an At/Bi composition in an nitric acid solution, evaporating the nitric acid solution, and reconstituting the residue in hydrochloric acid prior to chromatography or compared to a comparative process that requires destruction of a nitrate prior to chromatography. The process described herein isolates At in a particular percentage of its half-life. In some embodiments, the process is performed in less than about 20%, less than about 15%, less than about 10%, or less than about 5% of the half-life of At such as ²¹¹At.

It will be appreciated that the purified ²¹¹At isotope collected with the present system can have a range of uses. Astatine (At) may be useful as a radiolabel for therapeutics. For example, the astatine of the present embodiments can be included in products suitable for therapeutic medical applications such as treatment of cancer in human patients. In some embodiments, the process may further include labeling a therapeutic with the eluted At. This may be done directly with the column fraction of eluted At or may include concentrating the fraction containing At and suspending or dissolving the At in a solution used for the labeling step.

Alternatively, in some embodiments, the astatine can be stored and shipped within the column rather than eluted therefrom. It will be appreciated that in embodiments in which the column is shipped, astatine remains in the column and the fraction collection valves 328, as discussed with respect to FIG. 4, can be removed from the system 300 and/or used to filter waste from the column 320. To prepare the column for shipping, the column 320 can be dried to remove any excess fluid therefrom (S512). In some embodiments, air can be blown through the column to remove the excess fluid. Once the column is sufficiently dried, the column having the astatine stored on the resin bed therein can be packaged and shipped. A person skilled in the art will recognize that shipping a dry column containing astatine includes considerably less restrictions than those imposed on shipping of solutions containing the compound, e.g., the dissolution solution.

The astatine in the dried column can have a variety of uses. For example, in some embodiments, the dried column can be delivered to a facility for elution of the column to recover the astatine stored therein. In some aspects, the dried column can be used for labeling biomolecules. In some embodiments, the astatine can be used in the treatment of cancer by targeting cancer cells. For example, the radioactive decay of astatine can be utilized by adding astatine to a biologically relevant molecule, such as antitenascin monoclonal antibody 81C6 (ch81C6), F(ab′)₂, fragment of the murine IgG1 monoclonal antibody MX35, and/or anti-CD45 monoclonal antibody within the column. The astatine and the molecule can then be stripped from the column and injected into a body of a patient as a cancer-treating therapeutic.

It will be appreciated that the system of the present embodiments can be compact to allow ease of transport of the components of the system between various locations. For example, the system described above, along with all corresponding tubing, can fit in approximately a 1′x1′x1′ cube. In some embodiments, the system, including the dissolution box and the column, can be sufficiently compact to be placed and operated in a fume hood, glove box, or biosafety cabinet. Moreover, as discussed above, the dissolution and recovery of the astatine according to the presently disclosed methods can be performed without heating any portion of the system. The presently disclosed methods do not utilize additional chemical manipulation, such as conversion of the ionic media prior to separation, nor evaporation of the dissolution solution to separate, extract, and recover the astatine from the target material.

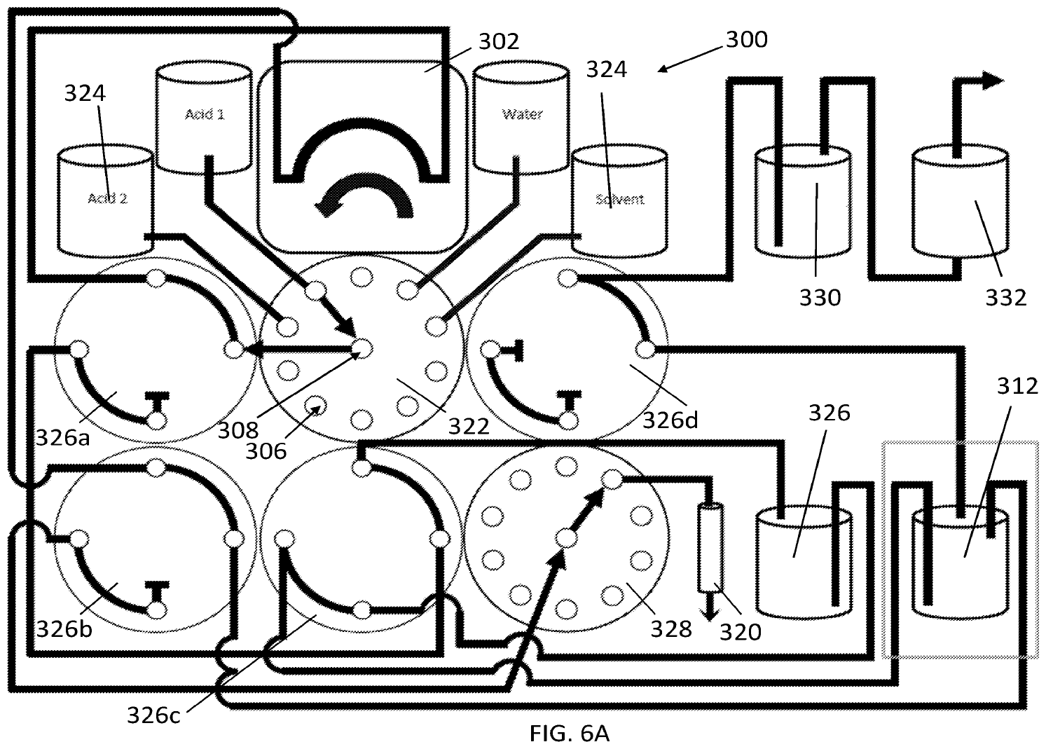

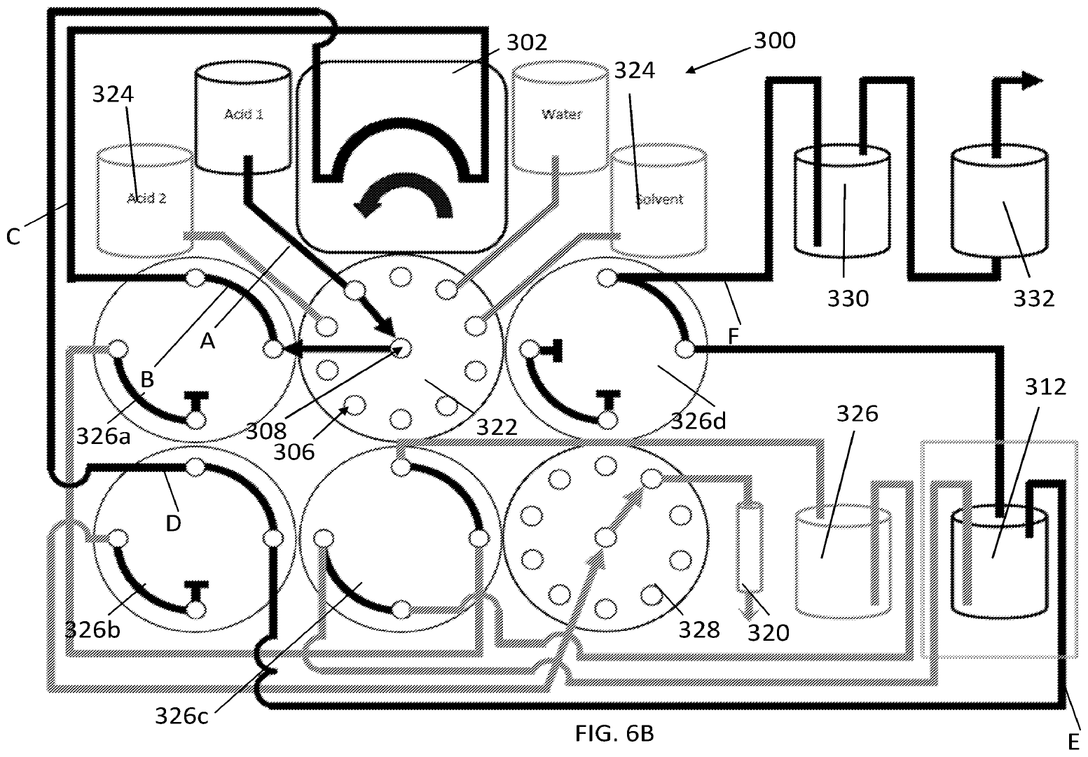

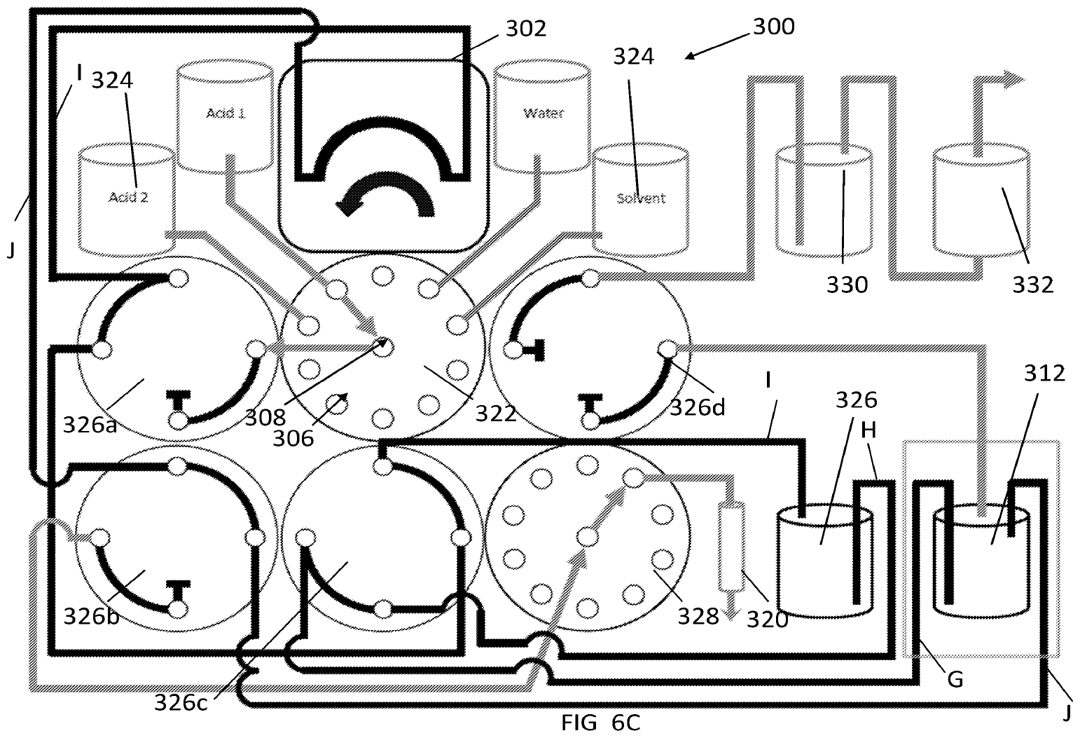

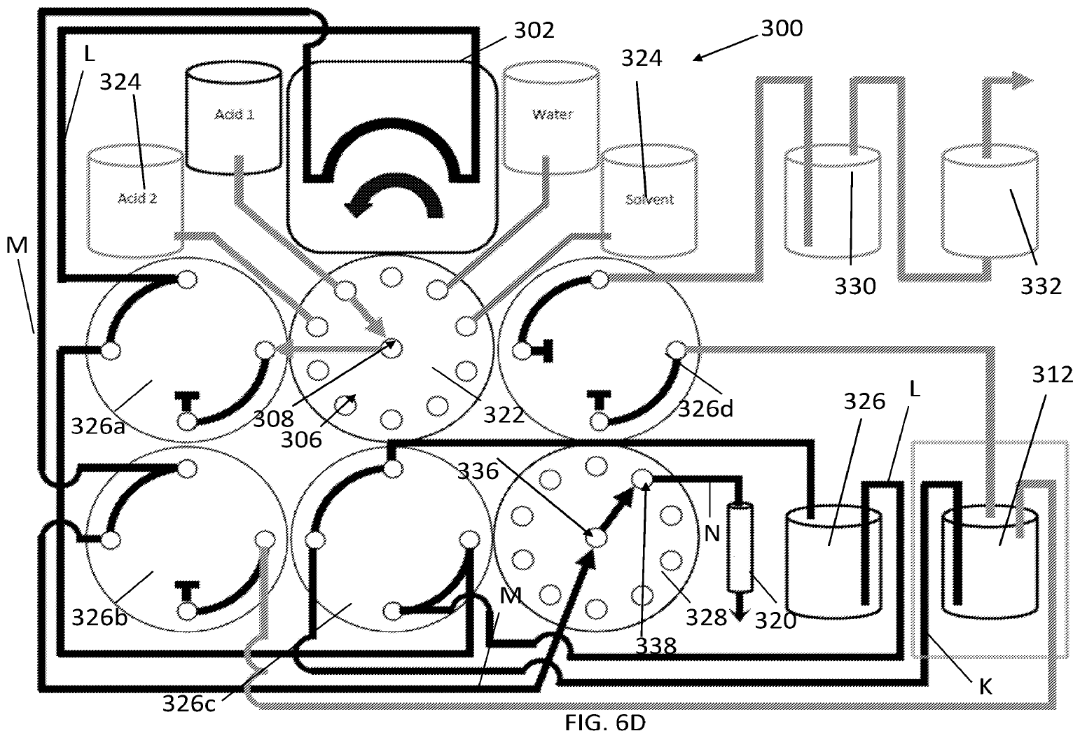

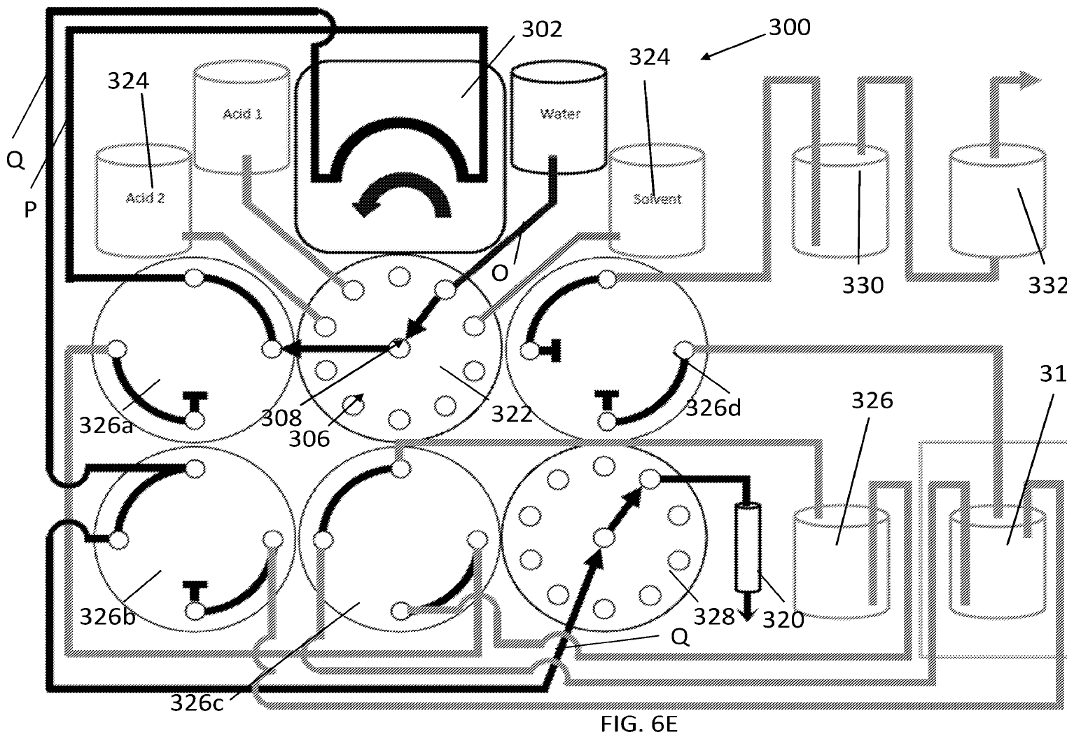

FIGS. 6A-6E illustrate the sequences of flows through the automated compound recovery system 300 for the steps of the method 500 in greater detail. For example, as shown in FIG. 6A, the solution selection valve 322 can be in fluid communication with a plurality of vials 324. The vials can include a number of fluids such as acids, water, and/or solvent stored therein, as shown. As discussed above, the solution selection valve 322 can include a plurality of inlets 306, with each inlet connected to one of the vials 324, and a single outlet 308 configured to flow the contents of the vials 324 throughout the system 300. Fluid flowing out through the outlet 308 can flow to the two-way selection valve 326a and to the pump 302. From the pump 302 the fluid can flow to the second two-way selection valve 326b and to the dissolution box 312 to dissolve the target material into the dissolution solution. From the dissolution box 312, the dissolution solution can, in some embodiments, flow through a third two-way selection valve 326c, to the product vial or QA device 326 for sampling. The dissolution box 312 can also be in fluid communication with a fourth two-way selection valve 326d to pass gaseous material, e.g., vapors, to a scrubber vat 330 and a charcoal vat 332 to remove astatine vapors. It will be appreciated that in some embodiments, the fourth two-way selection valve is configured to flow gas instead of liquid therethrough. The dissolution box 312 can also be in fluid communication with the column 320 and the fraction collection valve 328, as discussed in greater detail below.

FIG. 6B illustrates the sequence of flows that form the dissolution solution (S502) in system 300. As shown, acid, e.g., nitric acid, from the vial 324 can enter one of the plurality of inlets 306 of the solution selection valve 322 (A) and exit the outlet 308 to flow to the two-way selection valve 326a (B). From the two-way selection valve 326a, the acid flows to the pump 302 (C), which is then pumped through the two-way section valve 326b (D) and into the dissolution box 312 to form the dissolution solution (E). Once sufficiently dissolved, vapors produced by the formation of the dissolution solution can flow out of the dissolution box 312 to the fourth two-way selection valve 326d (F) and into the scrubber vat 330 and the charcoal vat 332. The vats 330, 332 can perform a safety cleansing of astatine to ensure that no vapors escape from solution. For example, gas, e.g., vapors, flowing out of the fourth two-way selection valve 326d can enter the scrubber vat 330 that contains a sodium hydroxide solution. The sodium hydroxide in the scrubber vat 330 can interact with the gas that is produced by the dissolution solution to neutralize astatine vapors emanating therefrom. The unreacted astatine vapors can then be passed to the charcoal vat 332 which acts as a filter to any gasses from the dissolution solution to prevent their escape from the gas into the lab and/or the ambient environment.

FIG. 6C illustrates flows for transfer of the dissolution solution (S505) from the dissolution box 312 to the QA device 326. As shown, the dissolution solution exits the dissolution box 312 in flow (G), and passes through the third two-way selection valve 326c to pass into the QA device 326 for sampling activity therefrom (H). Once sampled, the QA device 326 can be in fluid communication with the third two-way selection valve 326c and the two-way selection valve 326a via flow (I) to remove air from the QA device 326 to the pump 302. During operation, the pump 302 can suck out vapors from the QA device 326 by negative pressure, with the pump pumping out air, not liquid, from the QA device via flow (I). Pumping vapors out of the QA device 126 can act as a safety measure to ensure no leak exists in the system. The pump 302 can create a corresponding pressure in the dissolution box 312 via flow (J) that passes through the two-way selection valve 326b and passes into the dissolution box 312 to remove air and potentially harmful astatine gases therefrom. As noted above, use of the QA device 326 can be optional and, in some embodiments, sampling via the QA device 326 can become less frequent over time.

FIG. 6D illustrates loading of the column 320 in greater detail (S504). As shown, the dissolution solution can exit the dissolution box (K), pass through the third two-way selection valve 326c and into the product vial 326 for sampling. Once activity is measured, the dissolution solution can exit the QA device 326 via flow (L), pass through the third two-way selection valve 326c and the two-way selection valve 326a to flow to the pump 302. From the pump 302, the dissolution solution can be pumped (M) through the two-way selection valve 326b into the fraction collection valve 328. As shown, the fraction collection valve 328 can include a single inlet 336 and a plurality of outlets 338 that are each connected to a corresponding column 320. The dissolution solution can flow (M) into the inlet 336 towards the outlet 338 that corresponds to the column 320 for collection (N). In some embodiments, the column 320 and the fraction collection valve 328 can be juxtaposed. That is, in some embodiments, the flow of the dissolution solution (M) from the pump 302 can enter the column 320 prior to passing through the fraction collection valve 328. In such embodiments, fluid flow (N) exiting the column 320 can pass through the outlets 338 of the fraction collection valve 328 to be collected in the dispensing vials 329, as discussed in FIG. 4.

FIG. 6E illustrates washing the column 320 to rid the column of non-extracted species (S508) in greater detail. As shown, water can flow (0) through the solution selection valve 322, through an inlet of the plurality of inlets 306 and out through the outlet 308. Once the water exits the solution selection valve 322, it can pass through the two-way selection valve 326a and to the pump 302 (P). From the pump 302, the water can be pumped (Q) through the two-way selection valve 326b and into the fraction collection valve 328. From the fraction collection valve, the water can flow to the columns 320 to flush the columns from non-extracted species. A person skilled in the art will recognize that the sequence for washing the column can resemble that of drying the column (S512). For example, one of the inlets 306 of the solution selection valve 322 can be connected to the atmosphere to force air to travel through the line of the system 300 to dry the column 320.

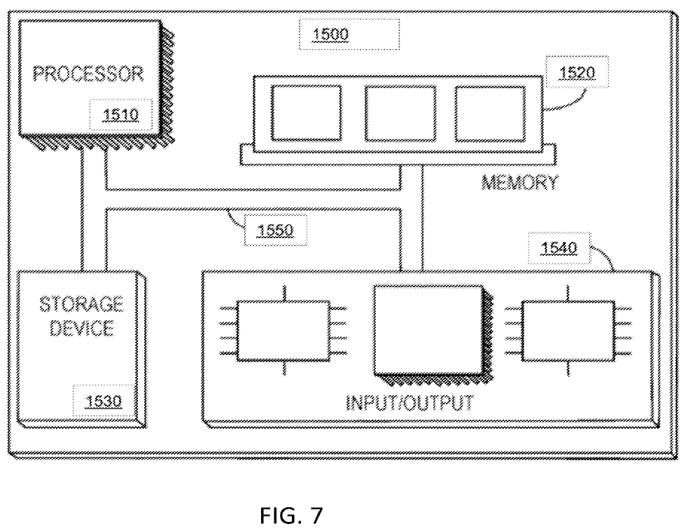

As noted above, in some embodiments, the system 100, 300 can be coupled and/or otherwise associated with the controller 200 configured to automate and/or remotely control the steps of the method 500. For example, the controller 200 can control fluid flow and/or pressure of the pump 302 and orientation of the valves 304 throughout the extraction process, with such configurations being understood in view of the present disclosures. FIG. 7 is a block diagram of one exemplary embodiment of a computer system 1500 upon which the controller or control system 200 of the present disclosures can be built, performed, trained, etc. For example, any modules or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, starting and stopping flow of fluid, control of fluid paths or pressures, and system configurations that can be automatic, in response to various parameters, and/or manually controlled by a user, including in response to signals, parameters, and so forth, and/or based on observation/preference, and so forth, among other features described in conjunction with the present disclosure. The controller 1500 can optimize operation in response to varying conditions of the solution entering the system, varying power pricing, and other factors that can relate to the energy efficiency, reliability, maintenance, or levelized cost of the solutions used for dissolving the irradiated target. In some instances, the controller 1500 can optimize operation in response to desired dissolution solution concentration, type of acidic medium, and/or operating pressures. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to fluid paths and system components, such as when and/or in response to what conditions the permeate-generating configuration and the flushing configuration should be implemented and/or different configurations for the various loops permitted by the system, storing the flush times, permeate salinity, and/or operating pressures, among other information, which can allow for a machine learning optimization of the system.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-state drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port or a 9 pin or 25 pin RS-232), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a fluid filtration system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, Javascript, LabVIEW, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-α-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

1. A compound recovery system, comprising:
a first column configured to extract astatine from a dissolution solution having astatine dissolved therein, the column having an extraction medium with a solvent associated therewith;
a pump in fluid communication with the column, the pump being configured to deliver the dissolution solution to the column; and
a control system in communication with the pump, the control system being configured to regulate flow of the dissolution solution through the pump via a signal, wherein the signal is automated or placed from a remote location.

2. The system of claim 1, further comprising a dissolution vessel in fluid communication with the pump and the column, the dissolution vessel being configured to form the dissolution solution by mixing an irradiated target material and a medium therein.

3. The system of claim 2, further comprising one or more selectors in fluid communication with the pump, the one or more selectors being configured to deliver the solvent or the dissolution solution therethrough.

4. The system of claim 3, wherein an orientation of the one or more selectors is determined by the signal from the control system.

5. The system of claim 3, wherein the control system is configured to be in communication with the pump and the one or more selectors substantially simultaneously.

6. The system of claim 3, wherein the one or more selectors contains a single inlet and a plurality of outlets.

7. The system of claim 3, wherein the one or more selectors contains a single outlet and a plurality of inlets.

8. The system of claim 4, wherein the one or more selectors are in fluid communication with one or more vials containing a solution therein, the pump being configured to deliver the medium through the one or more selectors into the dissolution vessel.

9. The system of claim 8, wherein the medium includes one or more of nitric acid, hydrobromic acid, hydrochloric acid, sulfuric acid, or perchloric acid.

10. The system of claim 1, wherein the extraction medium is a resin bed.

11. The system of claim 1, wherein the solvent can include one or more of octanone, 3-octanone, or 1-octanol.

12. The system of claim 1, wherein extraction of astatine occurs without heating.

13. The system of claim 1, further comprising a quality assurance device in fluid communication with the pump being configured to sample a portion of the dissolution solution.

14. The system of claim 1, further comprising a second column configured to receive a portion of the dissolution solution therethrough.

15. The system of claim 14, wherein the second column is arranged in series with the first column.

16. The system of claim 14, wherein the second column is arranged in parallel with the first column.

17. A method for compound recovery, the method comprising:
exposing a target material having one or more compounds therein to an acidic medium to dissolve the target material within the acidic medium to form a dissolution solution having the target material and the one or more compounds therein;
passing the dissolution solution through a chromatography column to extract the one or more compounds therefrom, the one or more compounds being extracted into a resin bed disposed within the chromatography column; and
washing the resin bed to remove non-extracted dissolution solution from the column,
wherein each of exposing the target material, passing the dissolution solution through the chromatography column, and washing the resin bed occurs in response to an automated signal or a signal placed from a remote location.

18. The method of claim 17, wherein the resin bed is washed with the acidic medium.

19. The method of claim 17, wherein the acidic medium comprises one or more of nitric acid, hydrobromic acid, hydrochloric acid, sulfuric acid, or perchloric acid.

20. (canceled)

21. The method of claim 17, wherein the dissolution solution is formed approximately over a range of about five minutes to about thirty minutes.

22.-30. (canceled)
